(19) United States
(12) Patent Application Publication
(10) Pub. No.: US 2014/0141729 A1
(43) Pub. Date: May 22, 2014

(54) SIGNAL TRANSCEIVER

(71) Applicant: NeWeb Corp., Hsinchu (TW)

(72) Inventors: I-Ching LAN, Hsinchu (TW); Chung-Min LAI, Hsinchu (TW); Chang-Hsiu HUANG, Hsinchu (TW)

(21) Appl. No.: 13/943,005

(22) Filed: Jul. 16, 2013

(30) Foreign Application Priority Data
Nov. 21, 2012 (TW) 101143380

(51) Int. Cl. H04B 1/40

(52) U.S. Cl. CPC H04B 1/40
USPC 455/73

(57) ABSTRACT

A signal transceiver is provided. The signal transceiver comprises a body, a first wave guide, at least one first feed conductor, a second wave guide, at least one second feed conductor, and a path-modulating structure. The first wave guide is formed in the body and comprises a first end and a second end, wherein a first opening is formed on the first end. The first feed conductor is disposed in the first wave guide and located on the second end. The second wave guide is formed in the body and comprises a third end and a fourth end, wherein a second opening is formed on the third end. The second feed conductor is disposed in the second wave guide and located on the fourth end. The path-modulating structure is substantially located between the first wave guide and the second wave guide.

### CROSS REFERENCE TO RELATED APPLICATIONS

This Application claims priority of Taiwan Patent Application No. 101143380, filed on Nov. 21, 2012, the entirety of which is incorporated by reference herein.

### BACKGROUND OF THE INVENTION

1. Field of the Invention

The present invention relates to a signal transceiver, and in particular to a satellite signal transceiver.

2. Description of the Related Art

Conventional satellite signal transceivers have a plurality of wave guides for receiving wireless signals from a. plurality of satellites. However, when the designated satellites are distributed too closely with each other, the wave guides of the satellite signal transceiver are correspondingly closely arranged on the satellite signal transceiver. The antennas inside the neighboring wave guide are therefore coupled with each other, which changes the impedance matching of the antennas and affects the radiation pattern thereof.

### BRIEF SUMMARY OF THE INVENTION

A signal transceiver is provided, comprising a body, a first wave guide, at least one first feed conductor, a second wave guide, at least one second feed conductor and a path-modulating structure. The body comprises an end surface. The first wave guide is formed in the body, and comprises a first end and a second end, wherein a first opening is formed on the first end, and is formed on the end surface of the body. The first feed conductor is disposed in the first wave guide and located on the second end. The second wave guide is formed in the body, and comprises a third end and a fourth end, wherein a second opening is formed on the third end, and is formed on the end surface of the body. The second feed conductor is disposed in the second wave guide and located on the fourth end. The path-modulating structure is substantially located between the first wave guide and the second wave guide, wherein the path-modulating structure is formed on the end surface of the body.

The embodiment of the invention is characteristic in that the first signal entering the second opening is partially offset with the first signal leaving the second opening due to the phase contrast by disposing the path-modulating structure to change the path length of the electric field. Therefore, the interference between the neighboring wave guides is reduced.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a signal transceiver of the first embodiment of the invention;

FIG. 2A shows a modified example of the signal transceiver of the first embodiment of the invention;

FIG. 2B shows another modified example of the signal transceiver of the first embodiment of the invention;

FIG. 2C shows another modified example of the signal transceiver of the first embodiment of the invention;

FIG. 3 shows the operating principles of the signal transceiver of the first embodiment of the invention;

FIG. 4 shows the cross-polarization radiation pattern of the signal transceiver of the embodiment of the invention;

FIG. 5 shows a signal transceiver of the second embodiment of the invention;

FIG. 6A shows a modified example of the signal transceiver of the second embodiment of the invention;

FIG. 6B shows another modified example of the signal transceiver of the second embodiment of the invention; and

FIG. 6C shows another modified example of the signal transceiver of the second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

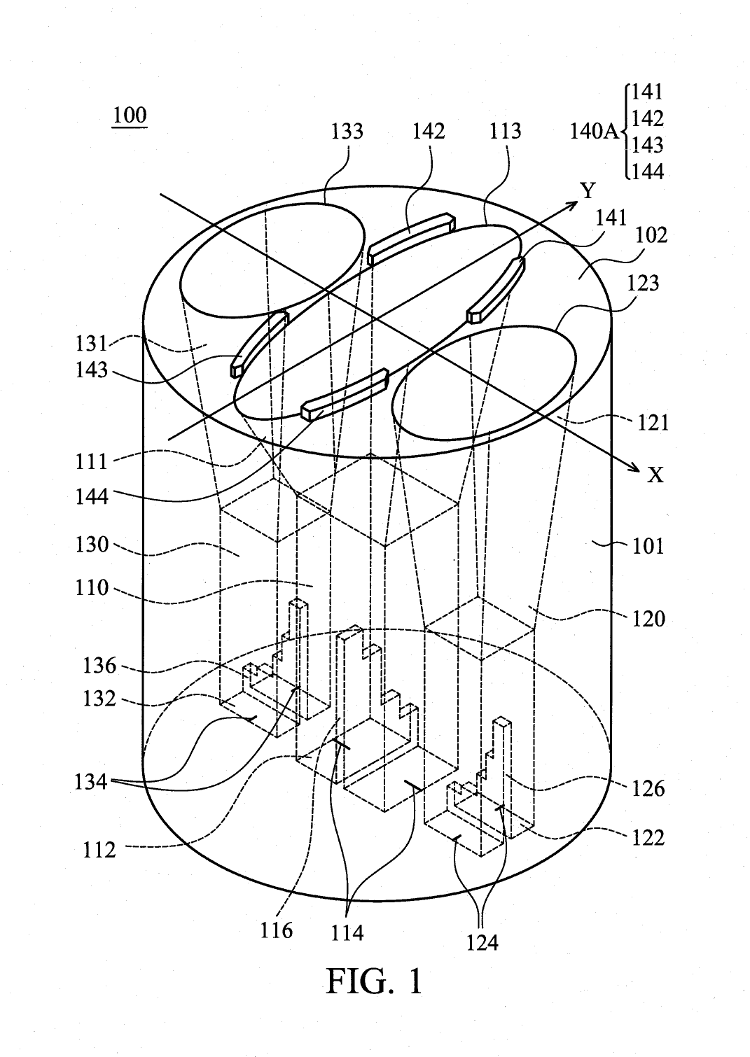

FIG. 1 shows a signal transceiver 100 of a first embodiment of the invention, comprising a body 101, a first wave guide 110, first feed conductors 114, a second wave guide 120, second feed conductors 124, a third wave guide 130, third feed conductors 134, and a path-modulating structure 140A. The body 101 comprises an end surface 102. The first wave guide 110 is formed in the body 101, and comprises a first end 111 and a second end 112, wherein a first opening 113 is formed on the first end 111, and is formed on the end surface 102 of the body 101. The first feed conductors 114 are disposed in the first wave guide 110 and located on the second end 112. The second wave guide 120 is formed in the body 101, and comprises a third end 121 and a fourth end 122, wherein a second opening 123 is formed on the third end 121, and is formed on the end surface 102 of the body 101. The second feed conductors 124 are disposed in the second wave guide 120 and located on the fourth end 122. The third wave guide 130 is formed in the body 101, and comprises a fifth end 131 and a sixth end 132, wherein a third opening 133 is formed on the fifth end 131, and is formed on the end surface 102 of the body 101. The third feed conductors 134 are disposed in the third wave guide 130 and located on the sixth end 132.

The first wave guide 110, the second wave guide 120 and the third wave guide 130 are located in a straight line. The path-modulating structure 140A is formed on the end surface 102 of the body 101, which is substantially located between the first wave 110 guide and the second wave guide 120, and is also substantially located between the first wave guide 110 and the third wave guide 130. In this embodiment, the path-modulating structure 140A is a protruding structure.

In this embodiment, the first opening 113 is ellipse shaped and has a major axis and a minor axis. The major axis is on the Y-axis, the minor axis is on the X-axis, and the first opening 113, the second opening 123, and the third opening 133 are aligned on the X-axis. The path-modulating structure 140A comprises a first protrusion 141, a second protrusion 142, a third protrusion 143 and a fourth protrusion 144, wherein the first protrusion 141, the second protrusion 142, the third protrusion 143 and the fourth protrusion 144 are located on an edge of the first opening 113, and are located in four quadrants defined by the X-axis and the Y-axis, wherein the X-axis is perpendicular to the Y-axis. However, the shape of the first, second and third openings are not limited thereby. In modified examples, the openings can be rectangular, circular or other shapes.

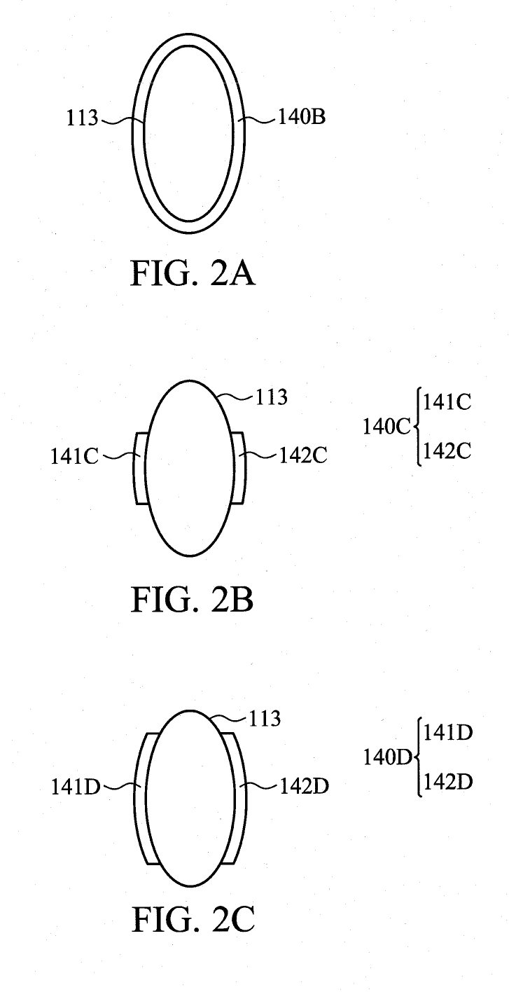

FIG. 2A shows a modified example of the first embodiment of the invention, wherein the path-modulating structure 140B is a continuous wall enclosing the first opening.

FIG. 2B shows another modified example of the first embodiment of the invention, wherein the path-modulating structure 140C comprises a first protrusion 141C and a second protrusion 142C, the first protrusion 141C and the second protrusion 142C are located on an edge of the first opening 113 and aligned along the X-axis, and the first protrusion 141C corresponds to the second protrusion 142C. FIG. 2C shows yet another modified example of the first embodiment of the invention, wherein the path-modulating structure 140D comprises a first protrusion 141D and a second protrusion 142D. Compared to the embodiment of FIG. 2B, the first protrusion 141D and the second protrusion 142D have increased length.

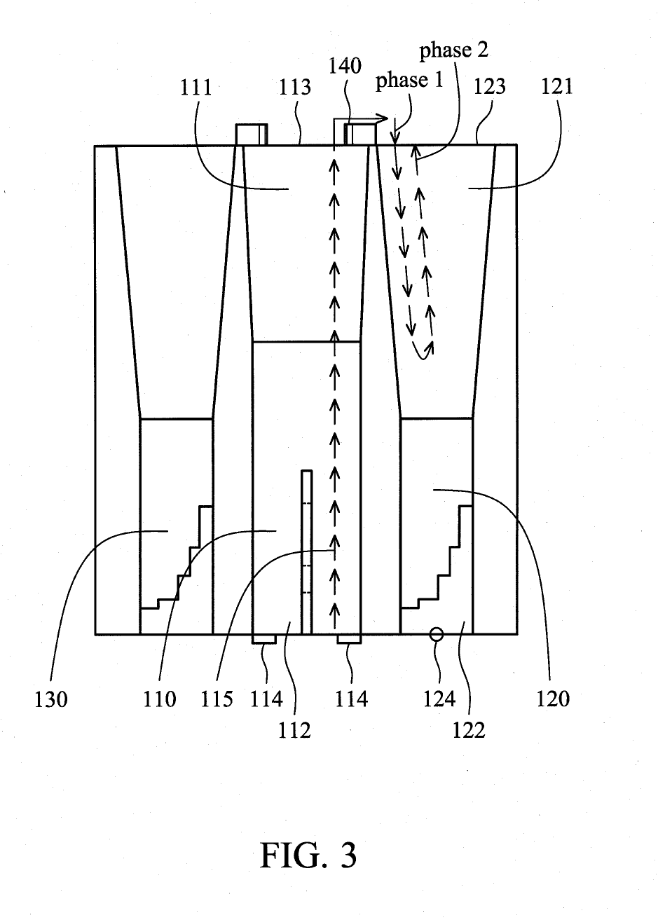

FIG. 3 shows the operating principles of the signal transceiver of the first embodiment of the invention, wherein the signal transceiver is in a “transmitting” mode. The radiation patterns of the signal transceiver in the “transmitting” mode and “receiving” mode are the same. The “transmitting” mode is taken as an example to clarify the description. As shown in FIG. 3, when the signal transceiver is operating, the first feed conductors 114 feed a first signal 115, and the first signal 115 travels from the first feed conductors 114, along an inner wall of the first wave guide 110 toward the first opening 113, leaving the first opening 113, passing through the path-modulating structure 140, entering the second wave guide 120 via the second opening 123, traveling along an inner wall of the second wave guide 120 toward the fourth end 122. Then, the first signal 115 is reflected in the second wave guide 120, traveling along the inner wall of the second wave guide 120 toward the second opening 123 and leaving the second opening 123. When the first signal 115 enters the second opening 123, the first signal 115 has a first phase (phase 1), and when the first signal 115 leaves the second opening 123, the first signal 115 has a second phase (phase 2), and the phase contrast between the first and second phases is 180 degrees. In the embodiment of the invention, the first signal 115 entering the second opening 123 is partially offset with the first signal 115 leaving the second opening 123 due to the phase contrast (180 degrees), and the actual quantity of the first signal 115 entering the second opening 123 is therefore reduced.

In one embodiment of the invention, the height of the protrusion is smaller than half of the air wavelength of the first signal 115.

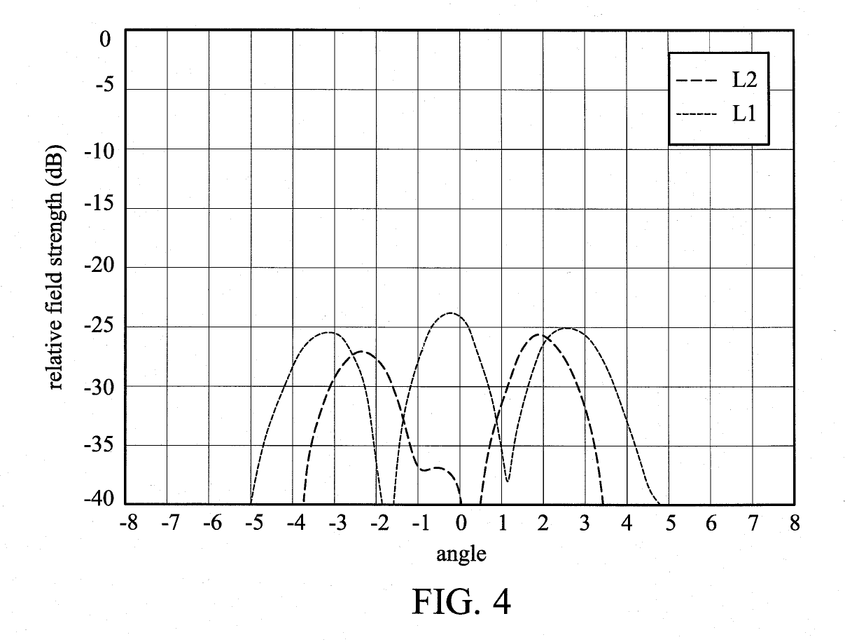

The embodiment of the invention is characteristic in that, the first signal entering the second opening is partially offset with the first signal leaving the second opening due to the phase contrast by disposing the path-modulating structure to change the path length of the electric field. Therefore, the interference between the neighboring wave guides is reduced. FIG. 4 shows the cross-polarization radiation pattern of the signal transceiver of the embodiment of the invention, wherein L1 is the radiation pattern without the path-modulating structure, and L2 is the radiation pattern with the path-modulating structure. As shown in FIG. 4, utilizing the path-modulating structure of the embodiment of the invention, the cross-polarization in zero degrees is obviously reduced.

In the embodiment above, the first, second and third wave guides are tapered structures. However, the invention is not limited thereby.

In the embodiment of the invention, the interference between the neighboring wave guides is reduced by the partial offsetting of the electric field due to the changing path length of the electric field. The interference between the neighboring wave guides in the embodiment of the invention is not reduced by means of shielding between the neighboring wave guides. Therefore, as shown in FIG. 1, the path-modulating structure is not necessarily sandwiched between the first and second wave guides, but still reduces the interference therebetween. The embodiment of the invention can also be utilized in situations in which the distance between the neighboring wave guides is approaching zero.

In one embodiment, the second feed conductors feed a second signal. The first signal is a low band signal, and the second signal is a high band signal. However, the invention is not limited thereby. For example, the frequency of the first signal can also be the same as that of the second signal.

With reference to FIG. 1, a polarizer 116 is disposed at the bottom of the first wave guide 110, a polarizer 126 is disposed at the bottom of the second wave guide 120, and a polarizer 136 is disposed at the bottom of the third wave guide 130. The polarizers 116, 126, 136 are utilized to transform linear polarized signals into circular polarized signals when the signal transceiver transmits signals, and to transform circular polarized signals into linear polarized signals when the signal transceiver receives signals.

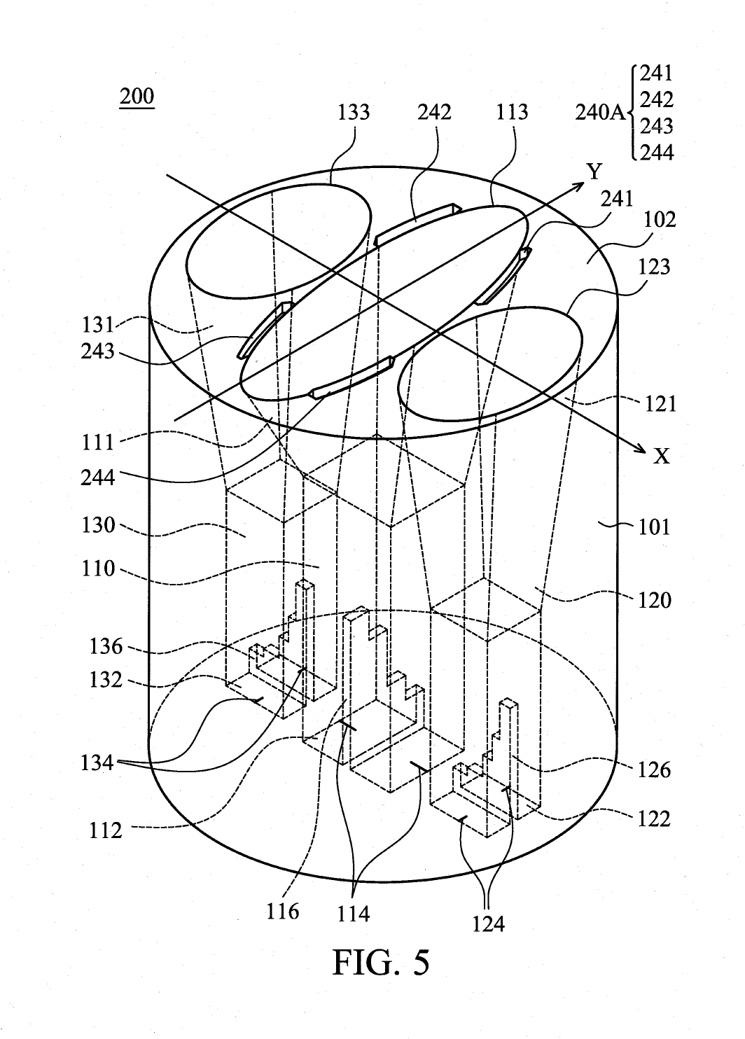

FIG. 5 shows a signal transceiver 200 of a second embodiment of the invention, wherein the path-modulating structure 240A is a recessed structure. The path-modulating structure 240A comprises a first recess 241, a second recess 242, a third recess 243 and a fourth recess 244, wherein the first recess 241, the second recess 242, the third recess 243 and the fourth recess 244 are located on an edge of the first opening 113, and are located in four quadrants defined by the X-axis and the Y-axis, wherein the X-axis is perpendicular to the Y-axis.

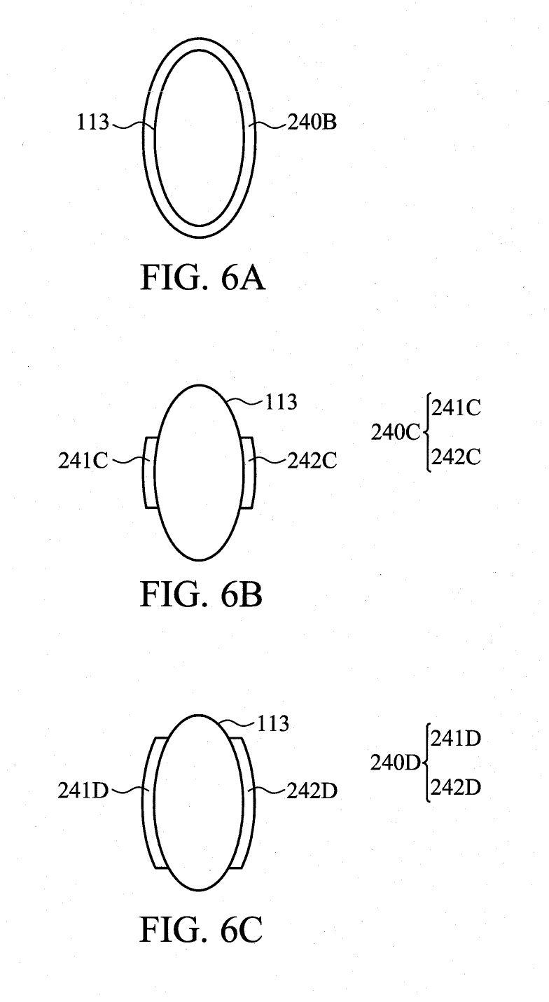

FIG. 6A shows a modified example of the second embodiment of the invention, wherein the path-modulating structure 240B is a continuous recess enclosing the first opening 113.

FIG. 6B shows another modified example of the second embodiment of the invention, wherein the path-modulating structure 240C comprises a first recess 241C and a second recess 242C. The first recess 241C and the second recess 242C are located on an edge of the first opening 113 and aligned along the X-axis, and the first recess 241C corresponds to the second recess 242C. FIG. 6C shows yet another modified example of the second embodiment of the invention, wherein the path-modulating structure 240D comprises a first recess 241D and a second recess 242D. Compared to the embodiment of FIG. 3B, the first recess 241D and the second recess 242D have increased length.

In one embodiment of the invention, the depth of the recess is smaller than half of the air wavelength of the first signal.

The path-modulating structure of the embodiment of the invention can be a protrusion, a recess, or other means which can modulate the path length of the electric field.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A signal transceiver, comprising:
a body, comprising an end surface;
a first wave guide, formed in the body and comprising a first end and a second end, wherein a first opening is formed on the first end, and is formed on the end surface of the body;
at least one first feed conductor, disposed in the first wave guide and located on the second end;
a second wave guide, formed in the body and comprising a third end and a fourth end, wherein a second opening is formed on the third end, and is formed on the end surface of the body;
at least one second feed conductor, disposed in the second wave guide and located on the fourth end; and
a path-modulating structure, substantially located between the first wave guide and the second wave guide, wherein the path-modulating structure is formed on the end surface of the body.

2. The signal transceiver as claimed in claim 1, wherein the first feed conductor feeds a first signal, and the first signal travels from the first feed conductor, along an inner wall of the first wave guide toward the first opening, leaving the first opening, passing through the path-modulating structure, entering the second wave guide via the second opening, traveling along an inner wall of the second wave guide toward the fourth end, and the first signal is reflected in the second wave guide, traveling along the inner wall of the second wave guide toward the second opening and leaving the second opening, wherein when the first signal enters the second opening, the first signal has a first phase, and when the first signal leaves the second opening, the first signal has a second phase, and a phase contrast between the first and second phase is 180 degrees.

3. The signal transceiver as claimed in claim 2, wherein the path-modulating structure is a protruding structure.

4. The signal transceiver as claimed in claim 3, wherein a height of the protrusion is smaller than half of an air wavelength of the first signal.

5. The signal transceiver as claimed in claim 3, wherein the path-modulating structure is a continuous wall enclosing the first opening.

6. The signal transceiver as claimed in claim 3, wherein the path-modulating structure comprises a first protrusion and a second protrusion, the first protrusion and the second protrusion are located on an edge of the first opening and aligned along an X-axis, and the first protrusion corresponds to the second protrusion.

7. The signal transceiver as claimed in claim 3, wherein the path-modulating structure comprises a first protrusion, a second protrusion, a third protrusion and a fourth protrusion, wherein the first protrusion, the second protrusion, the third protrusion and the fourth protrusion are located on an edge of the first opening, and are located in four quadrants defined by an X-axis and a Y-axis, and the X-axis is perpendicular to the Y-axis.

8. The signal transceiver as claimed in claim 2, wherein the path-modulating structure is a recessing structure.

9. The signal transceiver as claimed in claim 8, wherein the path-modulating structure is a continuous recess enclosing the first opening.

10. The signal transceiver as claimed in claim 8, wherein the path-modulating structure comprises a first recess and a second recess, the first recess and the second recess are located on an edge of the first opening and aligned along an X-axis, and the first recess corresponds to the second recess.

11. The signal transceiver as claimed in claim 8, wherein the path-modulating structure comprises a first recess, a second recess, a third recess and a fourth recess, wherein the first recess, the second recess, the third recess and the fourth recess are located on an edge of the first opening, and are located in four quadrants defined by an X-axis and a Y-axis, and the X-axis is perpendicular to the Y-axis.

12. The signal transceiver as claimed in claim 2, wherein the second feed conductor feeds a second signal, the first signal is a low-frequency signal, and the second signal is a high-frequency signal.

13. The signal transceiver as claimed in claim 2, wherein the second wave guide is a tapered structure, and a diameter of the third end is greater than a diameter of the fourth end.

14. The signal transceiver as claimed in claim 13, wherein the first wave guide is a tapered structure, and a diameter of the first end is greater than a diameter of the second end.

15. The signal transceiver as claimed in claim 1, further comprising a third wave guide and at least one third feed conductor, wherein the third wave guide is formed in the body and comprises a fifth end and a sixth end, wherein a third opening is formed on the fifth end, and is formed on the end surface of the body, the third feed conductor is disposed in the third wave guide and located on the sixth end, wherein the first wave guide, the second wave guide and the third wave guide are located in a straight line, and the path-modulating structure is also substantially located between the first wave guide and the third wave guide.

16. The signal transceiver as claimed in claim 1, wherein the first opening is ellipse shaped and has a major axis and a minor axis, the major axis is on a Y-axis, the minor axis is on an X-axis, and the first opening and the second opening are aligned on the X-axis.
